(19) United States
(12) Patent Application Publication
(10) Pub. No.: US 2016/0085227 A1
(43) Pub. Date: Mar. 24, 2016

(54) DEVICE FOR MANAGING AND CONFIGURING FIELD DEVICES IN AN AUTOMATION INSTALLATION

(71) Applicant: ABB TECHNOLOGY AG, Zuerich (CH)

(72) Inventors: Dirk Wagener, Stadthagen (DE); Christoph Welte, Neu-Ulm (DE); Marcus Heege, Kaisersesch (DE); Wolfgang Mahnke, Hettenleidelheim (DE); Marko Schlueter, Espelkamp (DE)

(21) Appl. No.: 14/857,835

(22) Filed: Sep. 18, 2015

(30) Foreign Application Priority Data
Sep. 19, 2014 (DE) 10 2014 013 943.3

(51) Int. Cl. G05B 19/05

(52) U.S. Cl. CPC G05B 19/056; G05B 2219/1122

(57) ABSTRACT

A device for managing and configuring field devices in an automation installation with a configuration tool that is designed to physically detect a field device in the automation installation, to logically incorporate it into the automation installation and to configure it in the automation installation, wherein, to this end, the configuration tool resorts to a prescribed first field-device-specific information packet that describes the functions and data of the field device at least in part. In order to ascertain the origin of a system report, it is proposed that the hierarchic structure of the automation installation be mapped in the configuration tool by nested geometric figures in a screen element. On each hierarchy level, each object is represented by a geometric figure. The geometric figures of each object of a superordinate hierarchy level each form a frame around the geometric figures of the objects of the respectively subordinate hierarchy level.

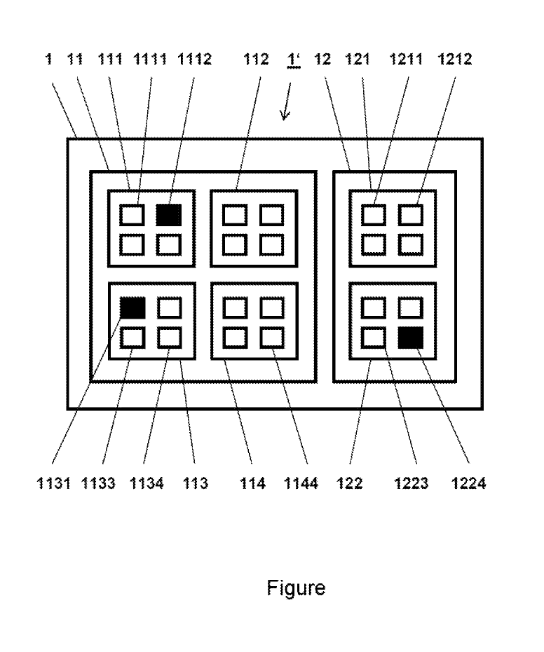

### CROSS-REFERENCE TO RELATED APPLICATIONS

Priority is claimed to German Patent Application No. DE 10 2014 013 943.3, filed on Sep. 19, 2014, the entire disclosure of which is hereby incorporated by reference herein.

### FIELD

The invention relates to a device for managing and configuring field devices in an automation installation. The invention is used, in particular, in process automation or machine control for controlling processes and/or installation components.

Automation systems for controlling a technical process or a technical installation usually comprise a control device (PLC) which is integrated in a group of a multiplicity of intelligent electrical devices. Intelligent electronic devices are microprocessor-based devices, for example protective and control devices, motor protective devices, intelligent switches and voltage regulators, frequency converters, pressure and temperature measuring transducers, flowmeters and actuators.

The article “FDI Device Integration—Best of Both Worlds”, atp edition June 2010, pages 16 to 19, discloses the practice of integrating field devices into an automation installation using the FDI concept (Field Device Integration IEC-62769). The basis of this concept is the provision of information for configuring field devices in a device-specific FDI packet. This FDI packet comprises a firmly predefined amount of information which consists of a device definition, business logic, a user interface description and user interface plug-ins. The device definition comprises management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices by means of EDD (electronic device description) technology IEC 61804, a device manufacturer provides an EDD which comprises information relating to the communication with the device, the business logic and the user interfaces, that is to say which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets are typically created by device manufacturers and are used by system manufacturers to integrate and configure the devices from the device manufacturers in their system.

In addition to an individual user element having different parameters, graphs and other elements, new windows and dialogs may also be defined in the EDD. In this case, a host has certain freedoms and can display a plurality of menus defined in the EDD in different windows at the same time, for example, or else user interfaces of different device entities.

In such a programming tool, information relating to the devices is visualized and functions, such as parameter setting, are executed. For this purpose, a device is first to be selected by the user from a multiplicity of devices.

Furthermore, in known programming tools, the same device is disadvantageously represented in various ways. Thus, a different device object and symbol is displayed in the tree structure than in the list representation of the devices. The device functionality also differs based on the display format. The display is not consistent and is therefore difficult for a user to learn. The different displays also differ with respect to device functionalities which the user can execute. Thus, the user cannot execute the same device functions in the list representation as if he chose the device object in the tree. The user must therefore know which device functions he can find and execute in which display.

A screen element, HMI device, automation system and computer program product for visualizing and projecting user texts which are used once and more than once and the associated points of use in a data processing system are known from DE 102 45 890 B4. What can be gathered from the disclosure is that the devices are provided for selection in a hierarchical tree structure, wherein a user text is associated with each branch which branches further and a combination of a user text and a point of use is associated with each branch which does not branch further. Details relating to a device are stored in nested menu levels. Hence, the operation and, in particular, the search for details relating to a device becomes a time-consuming process.

Industrial installations are regularly mapped in hierarchic structures. In software programs, such as configuration tools, these are typically displayed in a tree representation. In order to visualise the status of the installation, the status is presented on the last branch of the tree, for example by an icon, and said tree is then cumulatively transmitted to the superordinate nodes.

Disadvantageously, this tree representation loses overall sight of the status of the installation as a whole. Although it is possible to identify the branch of the tree in which there is a system state, for example a report of a problem, specific determination of the source object of the system report requires the forks in the tree to be searched. A complete overview of the installation with a presentation of all the forks is not possible in a tree representation.

### SUMMARY

An aspect of the invention provides a device for managing and configuring a field device in a hierarchically organized automation installation, the device comprising: a configuration tool designed to physically detect a plurality of field devices and apparatuses in the automation installation, to logically incorporate the plurality into the automation installation, and to configure the plurality in the automation installation, wherein a hierarchic structure of the automation installation is mapped in the configuration tool by nested geometric figures in a screen element, wherein, on each hierarchy level, each object is represented by a nested geometric figure, and wherein the nested geometric figures of each object of a superordinate hierarchy level each form a frame around the nested geometric figures of the objects of a respectively subordinate hierarchy level.

### BRIEF DESCRIPTION OF THE DRAWINGS

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

the FIGURE shows a screen element 1′ in the configuration tool depicting objects 1 to 1224 of a hierarchically structured automation installation by nested geometric figures.

### DETAILED DESCRIPTION

An aspect of the invention relates to a device for managing and configuring field devices in an automation installation, which can be used, in particular, in process automation or machine control for controlling processes and/or installation components.

An aspect of the invention provides a device for managing and configuring field devices in an automation installation in which the source object of a system report can be ascertained quickly and simply.

An aspect of the invention is a device for managing and configuring field devices in a hierarchically organized automation installation with a configuration tool that is designed to physically detect a plurality of devices and apparatuses in the automation installation, to logically incorporate them into the automation installation and to configure them in the automation installation.

An aspect of the invention provides for the hierarchic structure of the automation installation to be mapped in the configuration tool by nested geometric figures in a screen element. On each hierarchy level, each object is represented by a geometric figure. The geometric figures of each object of a superordinate hierarchy level each form a frame around the geometric figures of the objects of the respectively subordinate hierarchy level.

According to a further feature of the invention, the area of the geometric figure of a superordinate object is dependent on the number of objects that are subordinate to this object.

According to a further feature of the invention, the geometric figures of the subordinate objects of the bottommost hierarchy level have a fixed area size.

According to a further feature of the invention, each geometric figure has a prescribed color on the basis of the respective status of the associated object. In the simplest case, the geometric figures have the color green in the error-free state of the represented objects, while the geometric figures of erroneous represented objects have the color red.

According to a further feature of the invention, each geometric figure has a dynamically changing shape on the basis of the validity and/or currentness of the information stemming from the represented object.

In an automation installation having several thousand objects on different hierarchy levels, the inherently known timestamps of the status information for the individual objects are different. Advantageously, the currentness of the displayed information is presented simply and clearly on an object-individual basis.

To this end, provision may be made for the geometric figure representing the respective object to have a frame whose fill decreases in proportion to the currentness of the information stemming from the represented object.

According to a further feature of the invention, the geometric figure of a represented object is formed by a symbol on the basis of the respective status of the associated object.

According to a further feature of the invention, the area of the geometric figure of an object is dependent on the status of the configuration of the represented object. In this case, provision may be made for the area to be a measure of the frequency of change of the configuration of the represented object.

According to a further feature of the invention, each object of the automation installation has associated further information that is displayed on request. This request can be made by moving a pointer over the geometric figure, known as mouseover.

According to a further feature of the invention, the nested geometric figures are projected in a three-dimensional arrangement onto a two-dimensional display panel. In this case, the three-dimensional arrangement can be based on Cartesian, cylindrical or polar coordinates.

Particularly advantageously, an automation installation having a central device that is connected to peripheral devices via distributing transmission elements is represented as a three-dimensional arrangement in polar coordinates. By contrast, an automation installation having a basic backbone structure is advantageously represented as a three-dimensional arrangement in cylindrical coordinates.

Advantageously, this representation of the objects of a hierarchically organized automation installation achieves a rapid complete overview of the status of the automation installation. Furthermore, the dimension and the structure of the respective installation region is easy for the user to grasp.

It is possible to navigate within the nested geometric figures of the represented objects of the hierarchically structured automation installation by means of gestures and keyboard and/or mouse control. In this case, selection and activation of an object enlarges the selected object and the objects that are hierarchically subordinate to this object and presents them in more detail.

According to a further feature of the invention, it is possible to navigate within the nested geometric figures of the represented objects of the hierarchically structured automation installation by changing between the inherently known tree representation and the nested representation.

The invention is explained in more detail below using an exemplary embodiment. The single FIGURE basically shows a screen element 1′ in the configuration tool that depicts objects 1 to 1224 of a hierarchically structured automation installation by means of nested geometric figures.

The objects 1 to 1224 have one- to four-bit object descriptors, with the number of bits of the object descriptors indicating the hierarchy level. The highest hierarchy level accordingly has one-bit object descriptors and the lowest hierarchy level has four-bit object descriptors. Depending on the scope of the control or automation systems, a fifth and further hierarchy levels may be provided.

The first hierarchy level, the control level, of the control or automation system has at least one object 1 that is formed by a control device 1.

The control device 1 comprises, on the second hierarchy level, the objects 11 and 12, which are embodied as controllers 11 and 12.

The controllers 11 and 12 are equipped with interface cards 111 to 122, which form the objects 111 to 122 of the third hierarchy level. In this case, the interface cards 111 to 114 are associated with the controller 11, while the interface cards 121 and 122 belong to the controller 12 .

The fourth hierarchy level is provided with objects 1111 to 1224, which are referenced by way of example and which are connected as devices to the interface cards 111 to 122 of the third hierarchy level.

The objects 1 to 1224 of the automation installation are mapped in the configuration tool by nested geometric figures in the screen element 1′. In an extremely simple embodiment, the geometric figures are represented as rectangles. The geometric figures of each object 1 to 122 of a superordinate hierarchy level each form a frame around the geometric figures of the objects 11 to 1224 of the respectively subordinate hierarchy level.

The area of the geometric figure of a superordinate object 1, 11, 12 is dependent on the number of objects 111 to 1224 that are subordinate to this object 1, 11, 12. By contrast, the geometric figures of the subordinate objects 1111 to 1224 of the bottommost hierarchy level have a fixed area size.

Each geometric figure has a prescribed color on the basis of the respective status of the associated object 1 to 1224. In the FIGURE, the objects 1112, 1131 and 1224 are represented by a rectangle filled with color, while all the other objects of the fourth hierarchy level are represented by rectangular frames. The fill of the rectangle of the objects 1112, 1131 and 1224 indicates that the status of said objects differs from the status of the other objects of the fourth hierarchy level. Thus, provision may be made for a rectangle filled with color to indicate an error state of the object in question 1112, 1131 and 1224.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

1′ Screen element
1 to 1224 Object

1. A device for managing and configuring a field device in a hierarchically organized automation installation, the device comprising:
a configuration tool designed to physically detect a plurality of field devices and apparatuses in the automation installation, to logically incorporate the plurality into the automation installation, and to configure the plurality in the automation installation,
wherein a hierarchic structure of the automation installation is mapped in the configuration tool by nested geometric figures in a screen element, the hierarchic structure having a plurality of hierarchy levels, each having a plurality of objects,
wherein, on each hierarchy level, each object is represented by a nested geometric figure, and
wherein the nested geometric figures of each object of a superordinate hierarchy level each form a frame around the nested geometric figures of the objects of a respectively subordinate hierarchy level.

2. The device of claim 1, wherein an area of the nested geometric figure of a superordinate object is dependent on the number of objects that are subordinate to this object.

3. The device of claim 1, wherein the nested geometric figures of the subordinate objects of a bottommost hierarchy level have a fixed area size.

4. The device of claim 1, wherein each nested geometric figure has a prescribed color based on a respective status of an associated object.

5. The device of claim 1, wherein each nested geometric figure has a dynamically changing shape based on a validity and/or currentness of information stemming from a represented object.

6. The device of claim 1, wherein the nested geometric figure of a represented object is formed by a symbol based on a respective status of an associated object.

7. The device of claim 1, wherein an area of the nested geometric figure of an object depends on a configuration status of a represented object.

8. The device of claim 1, wherein each object of the automation installation includes associated further information that is displayed on request.

9. The device of claim 1, wherein the nested geometric figures are projected in a three-dimensional arrangement onto a two-dimensional display panel.

10. The device of claim 1, configured to navigate within the nested geometric figures of represented objects of the hierarchically structured automation installation by changing between a tree representation and a nested representation.

11. The device of claim 5, wherein each nested geometric figure has a dynamically changing shape based on the validity of the information stemming from the represented object.

12. The device of claim 5, wherein each nested geometric figure has a dynamically changing shape based on the currentness of the information stemming from the represented object.
